(19) United States
(12) Patent Application Publication
(10) Pub. No.: US 2026/0147710 A1
(43) Pub. Date: May 28, 2026

(54) USE CONTROL METHOD FOR CACHE RESOURCES AND ELECTRONIC DEVICE

(71) Applicant: Smarter Silicon (Shanghai) Technologies Co., Ltd., Shanghai (CN)

(72) Inventors: Weidong GUAN, Shanghai (CN); Nianfu BAI, Shanghai (CN)

(21) Appl. No.: 19/400,571

(22) Filed: Nov. 25, 2025

(30) Foreign Application Priority Data
Nov. 26, 2024 (CN) 202411708748.7

(51) Int. Cl. G06F 12/0871; G06F 12/1045; G06F 13/16

(52) U.S. Cl. CPC G06F 12/0871; G06F 12/1045; G06F 13/1668

(57) ABSTRACT

A control method includes obtaining an access request initiated by a target object in an electronic device, and determining, in response to the access request meeting a condition, a first partition identity of the target object and a second partition identity corresponding to a physical address to be accessed by the access request. The second partition identity is associated with a memory space address including the physical address. The method further includes determining a target resource allocation policy based on the first partition identity and the second partition identity, allocating corresponding cache space to the target object according to the resource allocation policy, and caching associated data needed to process the access request in the cache space.

### CROSS-REFERENCE TO RELATED APPLICATION

This application claims priority to Chinese Patent Application No. 202411708748.7, filed on Nov. 26, 2024, the entire content of which is incorporated herein by reference.

### TECHNICAL FIELD

The present disclosure generally relates to the resource control technology field and, more particularly, to a use control method for cache resources and an electronic device.

### BACKGROUND

Hardware modules such as processors and embedded controllers, as well as processes, in an electronic device need to share various cache resources of the electronic device, including cache devices such as memory. Therefore, hardware modules and processes will compete for cache resources, which will affect the bandwidth and performance of the hardware module and process accessing cache space, and affect the cache access efficiency.

To resolve the problem such as the decrease in cache access efficiency caused by blind competition for resources, currently, cache resources can be partitioned and managed according to the type of hardware module or process. However, even for the same hardware module or the same process, the demand for cache resources at different times may be different, so partition management according to the type of hardware module or process still makes it impossible to use cache resources reasonably, resulting in the ineffective use of cache resources.

### SUMMARY

In accordance with the disclosure, there is provided a control method including obtaining an access request initiated by a target object in an electronic device, and determining, in response to the access request meeting a condition, a first partition identity of the target object and a second partition identity corresponding to a physical address to be accessed by the access request. The second partition identity is associated with a memory space address including the physical address. The method further includes determining a target resource allocation policy based on the first partition identity and the second partition identity, allocating corresponding cache space to the target object according to the resource allocation policy, and caching associated data needed to process the access request in the cache space.

Also in accordance with the disclosure, there is provided an electronic device including a processor and a memory storing instructions that, when executed by the processor, cause the electronic device to obtain an access request initiated by a target object in the electronic device, and determine, in response to the access request meeting a condition, a first partition identity of the target object and a second partition identity corresponding to a physical address to be accessed by the access request. The second partition identity is associated with a memory space address including the physical address. The instructions, when executed by the processor, further cause the electronic device to determine a target resource allocation policy based on the first partition identity and the second partition identity, allocate corresponding cache space to the target object according to the resource allocation policy, and cache associated data needed to process the access request in the cache space.

Also in accordance with the disclosure, there is provided a non-transitory computer-readable storage medium storing instructions that, when executed by a processor, cause an electronic device including the processor to obtain an access request initiated by a target object in the electronic device, and determine, in response to the access request meeting a condition, a first partition identity of the target object and a second partition identity corresponding to a physical address to be accessed by the access request. The second partition identity is associated with a memory space address including the physical address. The instructions, when executed by the processor, further cause the electronic device to determine a target resource allocation policy based on the first partition identity and the second partition identity, allocate corresponding cache space to the target object according to the resource allocation policy, and cache associated data needed to process the access request in the cache space.

### BRIEF DESCRIPTION OF THE DRAWINGS

FIG. 1 is a schematic flowchart of a use control method for cache resources consistent with the present disclosure.

FIG. 2 is another schematic flowchart of a use control method for cache resources consistent with the present disclosure.

FIG. 3 is a schematic diagram showing an implementation of a memory management unit determining a resource allocation policy consistent with the present disclosure.

FIG. 4 is a schematic diagram showing an implementation of a memory management unit determining a resource control policy and allocating cache space for a target object.

FIG. 5 is another schematic flowchart of a use control method for cache resources consistent with the present disclosure.

FIG. 6 is a schematic diagram showing an implementation of transmitting an access request initiated by a target object to an SLC storage module via a memory management unit, and the SLC storage module performing resource partition management based on the access request consistent with the present disclosure.

FIG. 7 is a schematic structural diagram of an electronic device consistent with the present disclosure.

FIG. 8 is another schematic diagram of an electronic device consistent with the present disclosure.

### DETAILED DESCRIPTION OF THE EMBODIMENTS

The embodiments of the present application are described below with reference to the drawings. The terms used in the embodiments of the present application are only for explaining the specific embodiments of the present application and are not intended to limit the present application. It is known to those skilled in the art that, with the development of technology and the emergence of new scenarios, the technical solutions provided in the embodiments of the present application are also applicable to similar technical problems.

Terms such as “first,” “second” and the like in the specification and claims of this application and the above-mentioned drawings are used to distinguish similar objects and are not necessarily used to describe a specific order or sequence. The terms used in this manner are interchangeable under appropriate circumstances, and this is merely a way of distinguishing objects with the same attributes in the embodiments of the present application. Furthermore, terms such as “including,” “comprising,” or any variations thereof, are intended to cover a non-exclusive inclusion, so that a process, method, system, product, or device that includes a list of elements is not necessarily limited to those elements but may include other elements not expressly listed or inherent to such process, method, product, or device.

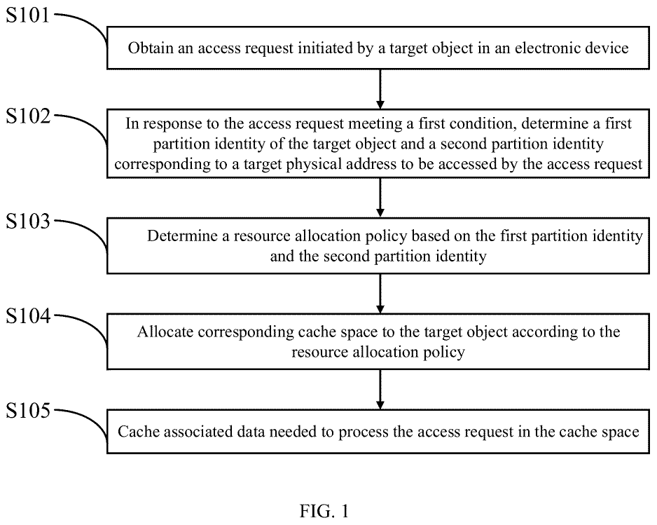

Embodiments of the present disclosure provide a use control method for cache resources, as shown in FIG. 1, which is a flowchart of the method. The method of this disclosure can be applied to electronic devices with cache memory. The cache memory may be of various types, without limitation. For example, the cache memory may be a cache memory in a system level cache (SLC) storage module. As another example, the cache memory may be a translation lookaside buffer (TLB) module in a memory management unit (MMU). Of course, the cache memory may be of other types, which are not limited. When the cache resources of the cache memory are shared by multiple objects, it is needed to reasonably allocate the resources to improve the utilization efficiency.

The method in this disclosure includes the following.

At S101, an access request initiated by a target object in an electronic device is obtained.

The target object can be an application or process running in the electronic device, or a hardware module of the electronic device that can initiate access requests, such as processor, embedded controller, display module, or image processing module.

The access request may be a read request, a write request, or a request related to cache resources. The specific request type and form are not limited by embodiments of the present disclosure.

At S102, in response to the access request meeting a first condition, a first partition identity of the target object and a second partition identity corresponding to a physical address to be accessed by the access request are determined. The physical address to be accessed is also referred to as a “target physical address.”

Consistent with this disclosure, the access request meeting the first condition is a trigger condition for caching associated data needed for processing the access request in a cache memory. In some embodiments, the access request meeting the first condition may be that the associated data needed for processing the access request cannot be found in the cache memory.

The first partition identity of the target object is used to uniquely identify the target object. The first partition identity is also an initial identity used to identify resource allocation policy applicable to the target object under a premise of partitioning management of cache resources in the cache memory. For example, a control unit corresponding to the cache memory may be pre-configured with partition identities corresponding to different objects. As such, the first partition identity corresponding to the target object may be determined according to the partition identities corresponding to different objects. As another example, a control unit corresponding to the cache memory may be configured with a generation policy for generating partition identities corresponding to objects. A first partition identity is generated for the target object based on the generation policy.

In the present disclosure, the second partition identity is associated with a memory space address including the physical address to be accessed by the access request. For example, the second partition identity may be a unique identity pre-assigned to the memory space address, or an identity generated based on the memory space address, which is not limited by embodiments of the present disclosure.

Consistent with this disclosure, the physical address to be accessed by the access request is the physical address corresponding to a memory storage space to be accessed by the access request.

In this disclosure, a memory space address including the physical address to be accessed by the access request is an address segment, that is, an address segment corresponding to a memory space. The size of the memory space corresponding to the memory space address can be set according to actual need, which is not limited by embodiments of the present disclosure.

At S103, a resource allocation policy is determined based on the first partition identity and the second partition identity.

Different from determining a resource allocation policy based only on the unique partition identity of the target object, the resource allocation policy in this disclosure is determined by combining the first partition identity of the target object and the second partition identity associated with the memory space address where the physical address to be accessed by the access request is located. Therefore, if the memory space addresses where the physical addresses to be accessed by different access requests initiated by the same target object are located are different, the resource allocation policy determined will also be different.

Consistent with the disclosure, different resource allocation policies are determined according to the memory space addresses to which the physical addresses accessed by the access requests initiated by the same target object belong. As such, partition management of cache resources for the same target object according to address segments is realized, and more granular resource partition management can be realized.

If cache resources are partitioned based solely on the first partition identity of a target object, then only one resource allocation policy applies to that target object. However, access requests initiated by the same process or hardware module at different times may have different requirements on using cache resources. Allocating cache resources according to the same resource allocation policy may result in inefficient use of limited cache resources.

When the scenarios in which the target object initiates access requests are different, the memory space addresses of the data being accessed are usually also different, and the needed resource allocation policies will also be different. For the same target object, multiple address segments (i.e., different memory space addresses) can be configured with corresponding resource allocation policies. Different resource allocation policies can be provided based on the memory space addresses and the sizes of the memory spaces corresponding to the memory space addresses, to meet the needs of different access scenarios.

For example, assume that resource allocation policies are configured for five address segments, respectively, for the target object. If 100 access requests are initiated by the target object, then the 100 access requests will be mapped to the five address segments, i.e., corresponding to five different resource allocation policies. This allows for more reasonable configuration of resource allocation policies based on access needs, and naturally enables more reasonable allocation of cache resources.

There are many ways to determine the specific resource allocation policy. For example, resource allocation policies corresponding to different combinations of first partition identity and the second partition identity may be pre-configured. On this basis, after the first partition identity and the second partition identity are determined, the resource allocation policy corresponding to the first partition identity and the second partition identity may be determined through querying.

As another example, the first partition identity and the second partition identity can be integrated into a third partition identity, and a resource allocation policy corresponding to the third partition identity can be determined. Based on the candidate resource allocation policies corresponding to different configured partition identities, the resource allocation policy corresponding to the third partition identity can be determined through querying.

Obtaining the third partition identity by integration may include combining the first partition identity and the second partition identity into the third partition identity. For example, the first partition identity and the second partition identity are combined according to the rule that the first partition identity comes first and the second partition identity comes second.

Obtaining the third partition identity by integration may also include performing a logical operation on the first partition identity and the second partition identity to obtain the third partition identity. Of course, there are other ways to obtain the third partition identity by integration.

At S104, corresponding cache space is allocated to the target object according to the resource allocation policy. The cache space belongs to the storage space in the cache memory.

Consistent with the disclosure, the resource allocation policy includes at least the size of the allocatable cache space and may also include other cache resource characteristics such as the available bandwidth of the cache space. The cache space allocated to the target object can have the same size as the space configured in the resource allocation policy, and features such as available bandwidth corresponding to the cache space can also match relevant features configured in the resource allocation policy.

The resource allocation policy can be set according to actual needs.

For example, the resource allocation policy may be pre-configured. For each object that can initiate an access request, the resource allocation policy, corresponding to the object and each memory space address to which the physical address to be accessed by the access request initiated by the object may belong, can be determined based on one or more pieces of information including, for example, the memory space address, the type of the object, the space size and starting address corresponding to the memory space address, and the requirement type of the access request that accesses the memory space address.

Since each object is uniquely identified by its corresponding first partition identity, and each memory space address is uniquely identified by its corresponding second partition identity, the resource allocation policy corresponding to the object and the memory space address is the resource allocation policy corresponding to the first partition identity of the object and the second partition identity of the memory space address.

For example, if, based on the type of data resources specified by certain physical addresses accessed by the object, it is determined that the access corresponding to these physical addresses is usually a single access or a single continuous-address access, then it means that, after an access request to such physical addresses is received, the probability of receiving an access request to access these physical addresses again is very small. Thus there is no need to allocate too much cache space in the cache memory to store the data needed to process the access request. On this basis, when configuring a resource allocation policy based on the object and the memory space addresses corresponding to these physical addresses, the size of the allocatable cache space can be configured to be relatively small, or even zero.

Correspondingly, if it is determined that the object has a higher frequency of accessing physical addresses included in certain memory space address, then in the resource allocation policy corresponding to the object and the memory space address, a relatively larger allocatable cache space can be configured.

If an access request initiated by the object is not sensitive to access latency and bandwidth, the processing performance of the access request will not be affected even if the associated data needed to process the access request is not cached in the cache memory. In this case, for this object, when configuring a resource allocation policy for the memory space addresses corresponding to these access requests, the cache space size may be configured to be zero, or the allocatable cache space may be configured to be relatively small and the access bandwidth may be configured to be relatively low.

Correspondingly, if an access request initiated by an object is sensitive to access latency or bandwidth, then for this object, when configuring a resource allocation policy for the memory space addresses corresponding to this access request, a relatively large cache space and a relatively high access bandwidth can be configured.

For different access requests initiated by a same target object, the memory space addresses of the physical addresses needed to be accessed by the access requests and the access requirements of the access requests can also be different. Therefore, based on the target object and the access requirements of the access requests initiated by the target object, the allocable cache size and bandwidth in the resource allocation policies corresponding to the different address segments configured for the target object may also be different.

As described above, the size of the allocatable cache space in the resource allocation policy may be zero. In this case, based on the resource allocation policy, the cache space allocated to the target object is zero, i.e., there is no need to allocate cache space for the target object, and there is no need to execute the subsequent operation S105 to cache the associated data.

At S105, associated data needed to process the access request is cached in the cache space.

The associated data needed to process the access request may be data that is needed to be obtained to execute the processing of the access request and needs to be cached in the cache memory.

For example, the associated data needed may be address mapping information needed for address mapping of an access request. In this case, the address mapping information may be cached in a cache space of a TLB module in a memory management unit.

As another example, the associated data may be data that is needed to be accessed or operated by the access request. In this case, the data may be cached in the cache space of the SLC storage module.

The associated data may also be other data.

Consistent with the disclosure, in response to the access request initiated by the target object meeting a first condition, not only the first partition identity of the target object will be determined, but also the second partition identity will be determined based on the physical address to be accessed by the access request, and the resource allocation policy will be determined by considering both the first partition identity and the second partition identity. Since the second partition identity is related to the memory space address including the physical address to be accessed by the access request, if the memory space addresses to which the physical addresses to be accessed by different access requests initiated by the target object belongs are different, the resource allocation policies will also be different. This realizes provision of different resource allocation policies according to different memory space addresses for the same target object, which allows for more granular resource partition management of cache resources based on the access requirements of the target object and more reasonable allocation of cache resources to reduce resource waste.

The solution of the present disclosure can be applied to cache resource management of various cache memories in electronic devices. When the cache memories are different, the specific way of determining the resource allocation policy and caching the associated data corresponding to the access request in the cache memory may also vary.

For example, the obtained access request may include a target virtual address corresponding to the storage space to be accessed. In this case, reference can be made to relevant description in the above for the determination of the first partition identity corresponding to the target object. Determination of the second partition identity may include obtaining an address mapping relationship set based on the target virtual address, and obtaining the second partition identity recorded in the address mapping relationship set. The address mapping relationship set may include at least one mapping relationship, and each mapping relationship includes a virtual address and a physical address that correspond to each other. The address relationship set may include at least the mapping relationship between the target virtual address and a physical address.

Consistent with the present disclosure, a partition identity is added to each address mapping relationship set. Based on this, after the address mapping relationship set containing the target virtual address is obtained, the partition identity recorded in the address mapping relationship set can be obtained. For easy distinction, the partition identity in the address mapping relationship set is referred to as a second partition identity, and the second partition identity in the address mapping relationship set is the second partition identity corresponding to the physical address to be accessed by the access request.

The second partition identity is used to identify a segment of memory space specified by each physical address in the address mapping relationship set, i.e., to identify the memory space address including the physical address to be accessed by the access request.

Obtaining the address mapping relationship set may include obtaining the address mapping relationship set from an internal memory of an electronic device. For example, suppose the address mapping relationship needs to be obtained using a first cache module where a first cache memory is located, and the cache memory that stores associated data (i.e., cache memory that requires cache resource partition management) may be the first cache memory or a second cache memory other than the first cache memory, then the address mapping relationship needs to be obtained from the internal memory of the electronic device as long as the address mapping relationship set is not stored in the first cache memory.

Obtaining the address mapping relationship set may also include obtaining the address mapping relationship set cached in the first cache memory. For example, in the case where a first cache memory stores an address mapping relationship set corresponding to a target virtual address, if the cache resources of a second cache memory need partition management, then it is needed to obtain the address mapping relationship set cached in the first cache memory to obtain the second partition identity in the address mapping relationship set. Further, based on the second partition identity and the first partition identity of the target object, a resource allocation policy suitable for allocating cache space for the target object from the second cache memory is determined.

The internal memory of the electronic device may be a double data rate (DDR) dynamic synchronous random access memory (DDR memory for short), or other memory storage.

In one possible situation, an access request meeting a first condition may include, based on the target virtual address, the associated data needed to process the access request cannot be found in the first cache memory.

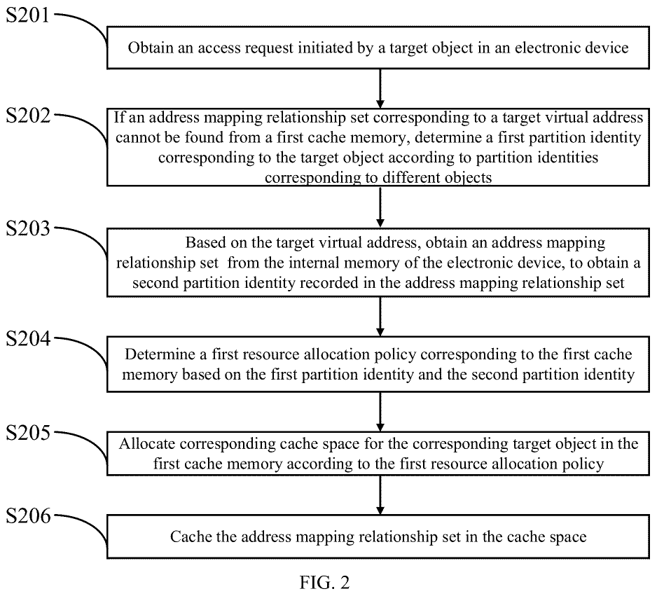

The following example is based on that the determination of the first partition identity and the second partition identity and the allocation of the cache space for the target object are both executed by the first cache module where the first cache memory is located, and address mapping relationship set might be associated data, as shown in FIG. 2. In this disclosure, the first cache module where the cache memory is located may include, in addition to a first cache memory, a first control unit. The first cache memory may be a cache memory in a memory management unit, and the first cache module where the first cache memory is located belongs to the memory management unit. The first cache module may include a control unit in a memory management unit and the first cache memory. For example, the first cache memory may be a TLB module.

Embodiments of the present disclosure provide another use control method for cache resources, as shown in FIG. 2.

At S201, an access request initiated by a target object in an electronic device is obtained.

The access request includes a target virtual address corresponding to a storage space to be accessed (also referred to as a “target storage space”). The storage space is a storage space pointed to by a physical address to be accessed (also referred to as a “target physical address”) in the access request, and the storage space belongs to a memory storage space.

At S202, if an address mapping relationship set corresponding to a target virtual address cannot be found from a first cache memory, a first partition identity corresponding to the target object is determined according to partition identities corresponding to different objects.

First partition identities corresponding to different objects are configured in a configuration space identifiable by a first control unit corresponding to the first cache memory. On this basis, the first control unit may determine the first partition identity corresponding to the target object from the configured first partition identities. For example, if the first cache memory is a TLB module in a memory management unit, the first partition identities of different objects can be configured in a configuration space identifiable by the memory management unit, and the first partition identity of the target object can be determined by the control unit of the memory management unit from the configuration space through querying.

The above example is based on a situation where an access request meets a first condition. The present disclosure also can be applied to other situations mentioned above.

At S203, based on the target virtual address, an address mapping relationship set is obtained from the internal memory of the electronic device to obtain a second partition identity recorded in the address mapping relationship set.

The address mapping relationship set includes at least a mapping relationship between a target virtual address and a physical address. The second partition identity is used to identify a segment of memory space pointed to by a physical address in the address mapping relationship set.

In this disclosure, it is possible to only obtain the address mapping relationship set corresponding to the target virtual address. In order to ensure that, after an access request is later received, the corresponding address mapping relationship set can be found from the first cache memory to reduce the number of accesses to the internal memory of the electronic device, the present disclosure may also include obtaining multiple mapping relationship sets including the address mapping relationship set corresponding to the target virtual object. For example, the multiple mapping relationship sets may include an address mapping relationship set corresponding to the target virtual object and at least one address mapping relationship set adjacent to the address mapping relationship set corresponding to the target virtual address.

At S204, a first resource allocation policy corresponding to the first cache memory is determined based on the first partition identity and the second partition identity.

The first resource allocation policy is a resource allocation policy for allocating cache resources in the first cache memory and is determined based on the first partition identity and the second partition identity.

For example, the first partition identity and the second partition identity are integrated into a third partition identity, and the resource allocation policy corresponding to the third partition identity is determined as the first resource allocation policy corresponding to the first cache memory.

The objects that can initiate access requests are limited in an electronic device, and the number of memory space addresses (i.e. address segments) that can be allocatable is also limited. Therefore, the third partition identities that can be configured are also limited. Based on this, the resource allocation policy corresponding to each third partition identity can be determined in advance according to information such as the type of each object and the access requirement characteristics of each memory space address, and the resource allocation policy corresponding to each third partition identity can be configured in the first control unit corresponding to the first cache memory.

For example, if the first cache memory is a TLB module in a memory management unit, the memory management unit can configure the resource allocation policy corresponding to each third partition identity in the memory system resource partitioning and monitoring (MPAM) management control unit.

At S205, according to the first resource allocation policy, corresponding cache space is allocated for the target object in the first cache memory.

Taking the first cache memory being a cache memory in the memory management unit as an example, the memory management unit can be an input/output memory management unit (IOMMU) or other types of memory management units.

The first cache memory of the memory management unit can be a TLB module for storing address mapping relationships. After the memory management unit receives an access request initiated by a target object, the memory management unit (such as a control unit in the memory management unit) queries the TLB module based on the target virtual address carried in the access request to determine whether an address mapping relationship set containing the target virtual address is cached therein. If the address mapping relationship set corresponding to the target virtual address does not exist in the TLB, the memory management unit may obtain an address mapping relationship set corresponding to the target virtual address from an internal memory such as a DDR memory of the electronic device, and obtain a second partition identity recorded in the address mapping relationship set.

For example, in the internal memory of an electronic device, a page table can be used to store mapping relationships between different virtual addresses and physical addresses. Each page table can include at least one page table descriptor, and each page table descriptor can store at least one set of mapping relationships between virtual addresses and physical addresses. Therefore, each page table descriptor can be considered as an address mapping relationship set. Consistent with this disclosure, a second partition identity can be added to the page table descriptor. For example, page table descriptor can record a page-based hardware attribute (PBHA) value. The PBHA values in different page table descriptors are different. In this case, the PBHA value can be used as a second partition identity.

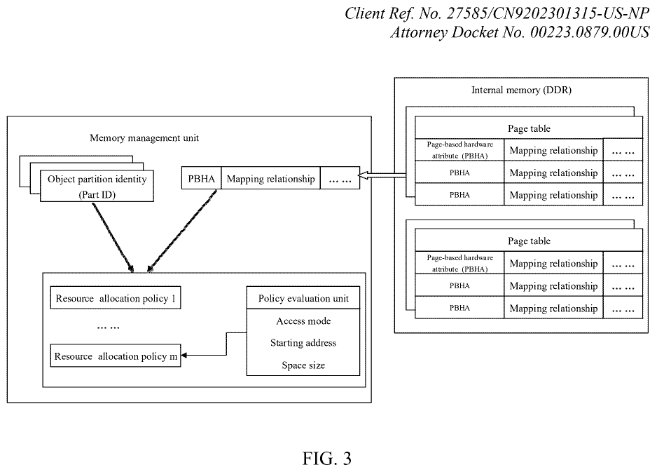

FIG. 3 is a schematic diagram showing determination of a resource allocation policy by a memory management unit.

In FIG. 3, the internal memory of an electronic device being DDR memory is used as an example. Multiple page tables are cached in the DDR memory. Each page table includes multiple page table descriptors, with each row in the page table being a page table descriptor. As shown in FIG. 3, each page table descriptor records at least one mapping relationship between a virtual address and a physical address. Furthermore, each page table descriptor is assigned with a PBHA value. Of course, the page table descriptor can also record other information.

As shown in FIG. 3, memory management unit can be preconfigured with multiple object partition identities (Part IDs). Each object's Part ID is the object's first partition identity. After receiving an access request from a target object, the memory management unit can find the target object's Part ID by querying.

FIG. 3 illustrates the example of a situation where the TLB module does not have a page table descriptor corresponding to the target virtual address carried in the access request. Based on this, the memory management unit obtains at least the page table descriptor corresponding to the target virtual address from the electronic device's DDR memory, thereby obtaining the PBHA value recorded in that page table descriptor.

Based on this, the memory management unit can combine the target object's Part ID and the PBHA value in the page table descriptor corresponding to the target virtual address into a final partition identity, i.e., a third partition identity.

FIG. 3 also shows that for each object that may initiate an access request and the memory space address corresponding to each page table descriptor, the memory management unit can use a policy evaluation unit to determine the resource allocation policy corresponding to different object Part IDs and different PBHA values. Because different object Part IDs and different PBHA values correspond to different third partition identities, the memory management unit uses the policy evaluation unit to determine the resource allocation policy corresponding to each third partition identity.

The policy evaluation unit can pre-determine a resource allocation policy corresponding to the object and the PBHA value in the corresponding page table descriptor, based on one or more pieces of information such as the starting address, space size, and possible access mode of the memory space corresponding to the page table descriptor.

For example, for each object, the memory space address to which the physical address that the object may access belongs can be determined, and, based on the memory space size corresponding to the memory space address, etc., the number of cache blocks in the TLB module that the object needs to occupy under the premise that the object can reliably access the memory space and effectively avoid TLB flushing, can be determined. Consequently, for the third partition identity corresponding to the object's Part ID and the PBHA value corresponding to the memory space address, the corresponding number of cache blocks is allocated, as available cache resources corresponding to the third partition identity, in the resource allocation policy. The size of each cache block allocated in the TLB module can be set based on actual needs. For example, the size of each cache block can be the same as the space needed for a page table descriptor.

As another example, for each object, if the access request initiated by the object to a certain memory space address is limited to a single access, then when configuring the resource allocation policy for the third partition identity corresponding to the object and the memory space address, the number of cache blocks that can be allocated in the TLB module in the resource allocation policy may be configured to be zero or relatively small.

As another example, if, for each object, the access requests initiated by the object to a certain memory space address are sensitive to access latency and bandwidth, in the resource allocation policy corresponding to the corresponding third partition identity, the number of cache blocks that can be allocated in the TLB module may be configured to be larger and the access bandwidth to be higher.

For ease of distinction, a pre-configured resource allocation policy can be referred to as a candidate resource allocation policy. Based on this, the memory management unit can find the resource allocation policy corresponding to the currently determined third partition identity through querying based on at least one configured candidate resource allocation policy.

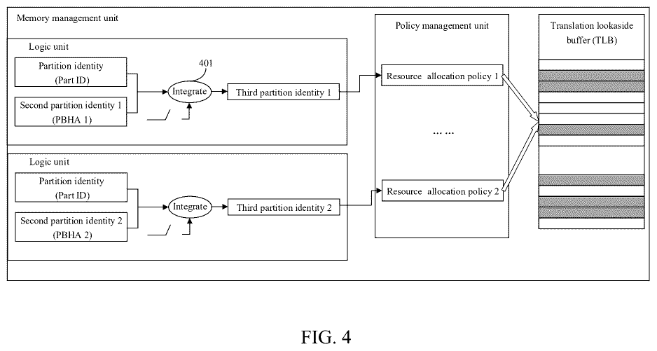

The memory management unit can integrate the Part ID of the target object and the PBHA value in the page table descriptor into the third partition identity in various ways. In one possible embodiment, the memory management unit may further include a logic unit and a policy management unit. The memory management unit can utilize the logic unit to integrate the target object's Part ID and the corresponding PBHA value into a third partition identity. FIG. 4 shows an example of determining a resource control policy and allocating cache space for a target object in the memory management unit.

As can be seen in FIG. 4, a policy enable switch 401 is provided in the logic unit of the memory management unit. The policy enable switch 401 can control whether the logic unit performs resource partition management of the TLB module based only on the first partition identity of the target object, or based on the first partition identity of the target object and the second partition identity corresponding to the access request.

If the policy enable switch is on, it indicates that resource partition management of the TLB module is performed based on the first partition identity of the target object and the second partition identity corresponding to the access request. Based on this, after obtaining a partition identity (Part ID) of the target object and second partition identity 1 (PBHA1 in FIG. 4) corresponding to the target virtual address of an access request from the control unit of the memory management unit, the logic unit will integrate the Part ID and second partition identity 1 into third partition identity 1.

To better understand the identity integration operations performed by the logical unit for different access requests, FIG. 4 also illustrates an example in which the logical unit obtains the target object's Part ID and second partition identity 2 (PBHA2 in FIG. 4) corresponding to the target virtual address of another access request from the control unit. In this case, the logical unit integrates the target object's Part ID and second partition identity 2 into third partition identity 2. The two logical units in FIG. 4 could be the same logical unit.

For example, assume that the first partition identity of the target object occupies at most n bits and the PBHA value corresponding to the access request occupies 4 bits, the operation performed by the logic unit can be expressed as follows,

$$fn = \{ \begin{matrix}partid [ n : 0 ] ≪ 4 , & en = 0 \\ partid [ n : 0 ] ≪ 4 + pbha [ 3 : 0 ] , & en = 1\end{matrix}$$

where, fn represents the identity integration result output by the logic unit. en=0 means integration is disabled, i.e., the first partition identity and the second partition identity are not integrated and the resource allocation policy is determined based on the first partition identity alone. en=1 means the integration is enabled, i.e., the first partition identity and the second partition identity are integrated into a third partition identity and the resource allocation policy is determined based on the third partition identity.

n is an integer greater than 1, and the specific value can be set based on actual needs.

In the above equation, partid represents the first partition identity, which can also be the partition identity of the target object. partid[n: 0]<<4 means that the first partition identity (from bit 0 to bit n) is shifted left by 4 bits. pbha [3:0] indicates that the PBHA value is 4 bits, that is, the PBHA value occupies 4 bits from bit 0 to bit 3. partid[n: 0]<<4+pbha [3:0] means that the first partition identity is shifted left by 4 bits and the PBHA value is added to the end of the first partition identity to obtain a third partition identity.

The above description is an example in which a PBHA value occupies four bits, but this disclosure does not limit the number of bits occupied by the PBHA value. For example, in actual applications, in order to achieve more fine-grained partition management, the number of bits occupied by the PBHA value can be increased.

After the memory management unit integrates to obtain the third partition identity through a logic unit, the resource allocation policy corresponding to the third partition identity can be determined from the policy management unit through querying. As shown in FIG. 4, different third partition identities correspond to different resource allocation policies. Correspondingly, the number of cache blocks allocated from the TLB based on different resource allocation policies is also different. In FIG. 4, white and gray bars are used to represent the cache blocks allocated based on the two different resource allocation policies.

In some embodiments, based on an Advanced RISC Machine (ARM) architecture, the policy management unit can store and query resource allocation policies corresponding to each third partition identity based on the MPAM control unit.

At S206, the address mapping relationship set is cached in the cache space.

For example, the first cache memory being the memory management unit is still used as an example. Since the first resource allocation policy can configure resource characteristics such as the size of the allocable cache space and the bandwidth, the memory management unit determines the number of cache blocks that need to be allocated to the target object in the TLB module and the access bandwidth of the cache blocks based on the first resource allocation policy, and then caches the address mapping relationship set in the allocated cache blocks according to the access bandwidth corresponding to the cache blocks.

If multiple address mapping relationship sets (e.g., page table descriptors) are obtained from an internal memory such as a DDR, and the cache space allocated based on the first resource allocation policy is insufficient to store all of the multiple address mapping relationship sets, then only a portion of the multiple address mapping relationship sets need to be stored.

In the embodiments corresponding to the possible situation above, in response to the access request meeting a second condition, the associated data needed to process the access request can also be obtained from the cache space corresponding to the target object.

If the access request meets the second condition, the cache space corresponding to the target object is allocated based on the resource allocation policy corresponding to the first partition identity and the second partition identity of the target object. For the specific method for obtaining the cache space corresponding to the target object, reference can be made to the above relevant description.

The access request meeting the second condition can include that the associated data needed for processing the access request is contained in the cache memory.

For example, in the case where the first partition identity and the second partition identity are determined by the first cache memory and cache space is allocated for the target object, the access request meets the second condition that an address mapping relationship set corresponding to the target virtual address exits in the first cache memory. Then, in response to the access request meeting the second condition, the address mapping relationship set corresponding to the target virtual address may be obtained from the cache space allocated by the first cache memory for the target object. Address mapping and other processes may then be performed on the access request based on the physical address corresponding to the target virtual address in the address mapping relationship set.

The above description is based on that the associated data needed to process the access request is the address mapping relationship set corresponding to the target virtual address. However, if the first cache module of the first cache memory only determines the first partition identity and the second partition identity, and the second cache module of the second cache memory determines the resource allocation policy corresponding to the second cache memory, then after the second cache module determines the cache space to be allocated to the target object in the second cache memory, the data to be processed by the access request may also be cached in that cache space.

The following describes another possible implementation method for determining a resource allocation policy and caching the associated data corresponding to the access request.

In this possible implementation method, the second cache module where the second cache memory is located may obtain the access request initiated by the target object, and the second cache module may include a second cache memory and a second control unit. For example, the second cache memory may belong to an SLC memory module. In this case, the second cache module in which the second cache memory resides may include an SLC memory and a control unit within the SLC memory module. Accordingly, the second cache memory may be an SLC memory. The second cache memory may also belong to other cache modules.

Correspondingly, based on the first partition identity and the second partition identity, a second resource allocation policy by which the second cache memory allocates cache resources for the target object may be determined. Cache space corresponding to the target object in the second cache memory may be allocated according to the second resource allocation policy.

The second cache memory is different from the first cache memory, and therefore, the associated data needed to process the access request to be stored by the second cache memory may also be different. In one embodiment, cache space allocated to the target object in the second cache memory can be determined, and the data to be processed by the access request can be cached in this cache space.

The access request in the electronic device needs to be processed by the memory management unit for address mapping before the request is sent to the cache memory in other cache modules. Based on this, taking the first cache memory being the cache memory in the memory management unit and the above implementation method as example, the process of determining resource allocation policy and caching data to be processed by the cache module where the second cache memory is located is described below.

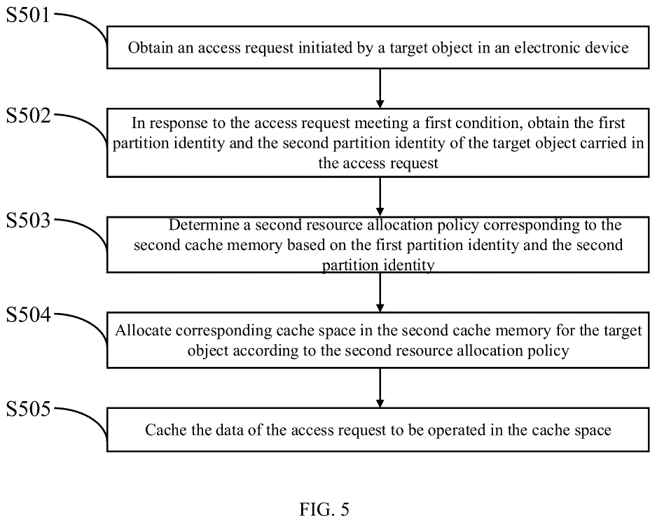

FIG. 5 is another flowchart of a use control method for cache resources consistent with the present disclosure. The method includes the following.

At S501, an access request initiated by a target object in an electronic device is obtained.

In this disclosure, the access request initiated by the target object can be obtained by a second cache module where a second cache memory is located. The access request can be transmitted to the second cache module by a memory management unit in which a first cache memory is located. Before transmitting the access request to the second cache module, the memory management unit can determine a first partition identity of the target object and a second partition identity corresponding to a target virtual address in the access request in accordance with the operations described in FIG. 2.

As described above, the access request can carry the first partition identity and the second partition identity.

Of course, the memory management unit can also map the target virtual address in the access request to a physical address. Therefore, the access request obtained by the second cache module may also carry the physical address corresponding to the target virtual address.

At S502, in response to the access request meeting the first condition, the first partition identity and the second partition identity of the target object carried in the access request are obtained.

As mentioned above, the first partition identity and the second partition identity are determined by the memory management unit, and the second partition identity is determined by the memory management unit based on the physical address to which the target virtual address in the access request is mapped.

In some embodiments, the access request meeting the first condition includes the data to be processed by the access request cannot be found in the second cache memory. For example, if the access request is a read request, the access request meeting the first condition includes that a first piece of data requested by the read request cannot be found in the second cache memory. If the access request is a write request, the access request meeting the first condition includes that a second piece of data requested by the write request cannot be found in the second cache memory. A write request can be used to request to modify data, delete data or write data, and therefore, a second piece of data to be processed by the write request can be the data to be modified, deleted or written by the write request.

At S503, based on the first partition identity and the second partition identity, a second resource allocation policy corresponding to the second cache memory is determined.

The second resource allocation policy is a resource allocation policy determined based on the first partition identity and the second partition identity to allocate cache resources in the second cache memory.

For example, the first partition identity and the second partition identity are integrated into a third partition identity, and based on the correspondence between different partition identities configured in the second cache module and candidate resource allocation policies, the resource allocation policy corresponding to the third partition identity may be determined as the second resource allocation policy.

At S504, corresponding cache space is allocated in the second cache memory for the target object according to the second resource allocation policy.

Consistent with the previous disclosure, the second resource allocation policy may configure the allocable size and available bandwidth of cache space. Correspondingly, based on the second resource allocation policy, the cache space in the second cache memory to be allocated to the target object may be determined, and the cache resource characteristics of the cache space, such as bandwidth, may also be matched with the second resource allocation policy.

At S505, the data to be processed by the access request is cached in the cache space.

For example, if the access request is a read request, the first piece of data to be read by the read request is obtained from the internal memory of an electronic device, and the first piece of data is cached in the cache space. And/or, if the access request is a write request, the second piece of data to be processed by the write request is cached in the cache space.

Consistent with the present disclosure, in response to the access request meeting the second condition, the data in the cache space allocated to the target object in the second cache memory can also be processed based on the access request. The access request meeting the second condition includes the data to be processed by the access request is in the second cache memory.

For example, if the access request is a read request, the first piece of data to be read by the read request can be obtained from the cache space allocated to the target object in the second cache memory; if the access request is a write request, a write operation is performed on the second piece of data cached in the cache space in the second cache memory based on the write request.

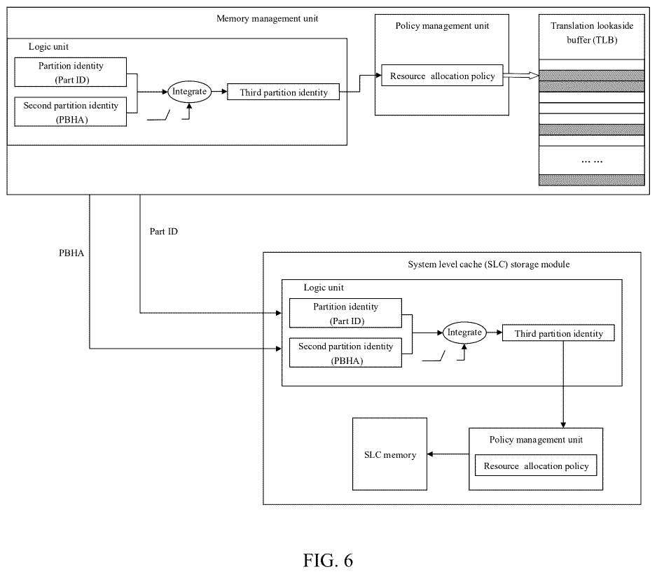

An example is described below with the first cache memory being a TLB module in the memory management unit, the second cache memory being an SLC memory in a SLC storage module, the first partition identity being the Part ID of the target object, and the second partition identity being the PBHA value corresponding to the physical address to be accessed by the access request. FIG. 6 is a schematic diagram showing an implementation of transmitting an access request initiated by a target object to an SLC storage module via a memory management unit, and the SLC storage module performing resource partition management based on the access request.

In FIG. 6, after the memory management unit obtains the access request initiated by the target object, if the TLB module of the memory management unit does not contain the page table descriptor corresponding to the target virtual address in the access request, then the memory management unit can obtain the page table descriptor from the DDR memory in accordance with above disclosure in FIG. 3 and FIG. 4, and cache the page table descriptor in the TLB module. In this case, after obtaining the page table descriptor, the memory management unit can determine the Part ID of the target object and the PBHA value in the page table descriptor. The memory management unit will transmit the access request carrying the Part ID and the PBHA value of the target object to the SLC storage module.

If the TLB module of the memory management unit caches the page table descriptor corresponding to the target virtual address in the access request, the memory management unit does not need to obtain the page table descriptor from the DDR memory of the electronic device, and thus the memory management unit does not need to determine the resource allocation policy corresponding to the Part ID and the PBHA value and cache the page table descriptor in the TLB module. In this case, the memory management unit can directly determine the Part ID of the target device, find the PBHA value from the page table descriptor through querying, and then transmit the access request carrying the Part ID and the PBHA value of the target object to the SLC storage module.

Based on the above, as shown in FIG. 6, the SLC storage module can integrate the Part ID and the PBHA value of the target object carried in the access request through the logic unit in the SLC storage module to obtain the third partition identity of the target object. The operations performed by the logic unit in the SLC storage module are similar to the operations performed by the logic unit in the memory management unit.

FIG. 6 takes the example of a logical unit configured within an SLC storage module. In actual applications, a logical unit connected to the SLC storage module can be configured externally to the SLC storage module, and this logical unit can transmits the integrated third partition identity to the SLC storage module.

After obtaining the third partition identity of the target object through the integration by the logical unit corresponding to the SLC storage module, the SLC storage module can find the resource allocation policy corresponding to the third partition identity through querying from its corresponding policy management unit. Similar to the above memory management unit, the policy management unit of the SLC storage module can also be an MPAM control unit.

The resource allocation policy corresponding to the third partition identity in the policy management unit of the SLC storage module can be different from the resource allocation policy configured for the third partition identity in the above memory management unit.

The SLC storage module can pre-determine the resource allocation policy corresponding to the target object's Part ID and the PBHA value based on one or more pieces of information such as the starting address, space size, and possible access mode of the memory space corresponding to the page table descriptor where the PBHA value is located.

For example, for each object, based on the memory space address to which the physical address that the object may access belongs, and the memory space size corresponding to the memory space address, etc., the object's access needs for the memory space corresponding to the memory space address and the storage space size in the SLC memory allocated to the object can be determined, and the allocatable storage space of the corresponding size can be configured in the resource allocation policy.

As another example, if the access request initiated by the object to a certain memory space address is not sensitive to access latency and bandwidth, based on the third partition identity corresponding to the object and the memory space address, when configuring a resource allocation policy for the third partition identity corresponding to the object and the memory space address in the policy management unit of the SLC storage module, a smaller storage space can be configured in the resource allocation policy, and the storage space to be allocated in the SLC memory can even be configured to zero.

The present disclosure also provides an electronic device. A schematic structural diagram of an electronic device is shown in FIG. 7.

The electronic device, as shown in FIG. 7, includes a cache module 71 and a policy control module 72 that is in communication with the cache module 71.

The cache module 71 is configured to obtain an access request initiated by a target object in an electronic device; and, in response to the access request meeting a first condition, determine a first partition identity of the target object and a second partition identity corresponding to a physical address to be accessed by the access request. The second partition address segment identity is related to the memory space address where the physical address is located.

The policy control module 72 is configured to determine the resource allocation policy based on the first partition identity and the second partition identity.

The cache module 71 is also configured to allocate corresponding cache space for the target object according to the resource allocation policy; and cache the associated data needed for processing the access request in the cache space.

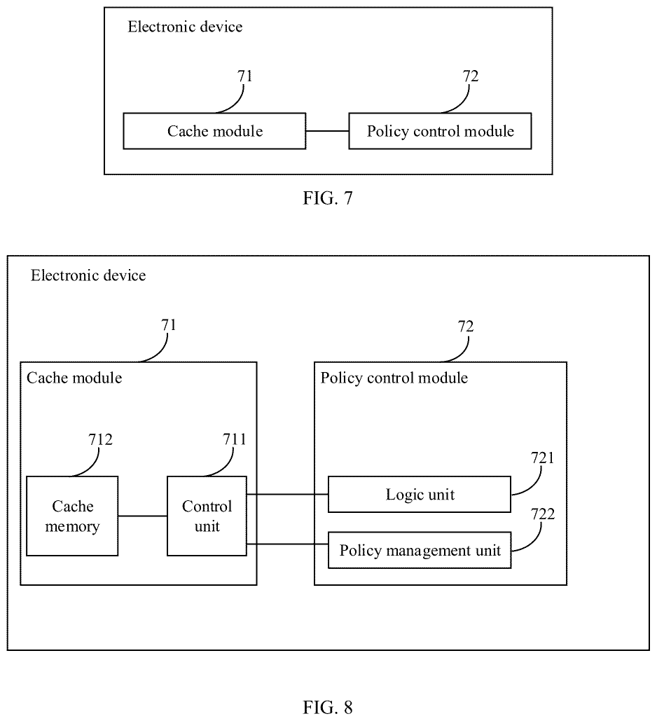

In one possible embodiment, the cache module includes a control unit and a cache memory for storing data. FIG. 8 shows another schematic structural diagram of an electronic device consistent with the disclosure.

In FIG. 8, the cache module 71 includes a control unit 711 and a cache memory 712 in communication connection with each other. The control unit 711 is also in communication connection with the policy control module 72.

On this basis, the control unit 711 is configured to obtain an access request initiated by a target object in an electronic device; in response to the access request meeting the first condition, determine the first partition identity of the target object and the second partition identity corresponding to the physical address to be accessed by the access request; and allocate corresponding cache space for the target object according to the resource allocation policy.

Correspondingly, the cache memory 712 is configured to cache the associated data needed to process the access request in the cache space.

For example, the electronic device includes a memory management unit. The memory management unit includes the cache module and the policy control module, and the control unit and cache memory in the cache module are the control unit and the TLB module in the memory management unit respectively.

As another example, the electronic device includes an SLC storage module. The SLC storage module includes the cache module and the policy control module, and the control unit and memory in the cache module are the control unit and the SLC memory in the SLC storage module respectively.

Further, in any of the above embodiments of the electronic device, the policy control module can include a logic unit and a policy management unit.

For example, the policy control module 72 in FIG. 8 includes a logic unit 721 and a policy management unit 722.

The logic unit 721 is configured to integrate the first partition identity and the second partition identity into a third partition identity.

The policy management unit 722 is configured to store at least one preset candidate resource allocation policy and determine a resource allocation policy corresponding to the third partition identity from the at least one candidate resource allocation policy.

In any of the above embodiments of the electronic device, the access request obtained by the cache module includes the target virtual address of the storage space to be accessed.

Correspondingly, when determining the first partition identity of the target object and the second partition identity corresponding to the physical address to be accessed by the access request, the cache module is configured to determine the first partition identity corresponding to the target object, according to the partition identities corresponding to different objects; based on the target virtual address, obtain the address mapping relationship set and the second partition identity recorded in the address mapping relationship set. The address mapping relationship set includes at least the mapping relationship between the target virtual address and the physical address, and the second partition identity is used to identify a segment of memory space pointed to by each physical address in the address mapping relationship set.

Further, the cache module includes a first control unit with communication connection and a first cache memory.

The policy control module includes a first policy control module, and the first policy control module is in communication with the first control unit.

The first control unit is configured to obtain an access request initiated by a target object in an electronic device; in response to the access request meeting a first condition, determine a first partition identity corresponding to the target object according to different partition identities corresponding to different objects; based on the target virtual address, obtain an address mapping relationship and a second partition identity recorded in the address mapping relationship set.

The first policy control module is configured to determine the first resource allocation policy corresponding to the first cache memory based on the first partition identity and the second partition identity.

The first control unit is also configured to allocate corresponding cache space for the target object in the first cache memory according to the first resource allocation policy.

The first cache memory is configured to cache the address mapping relationship set in the cache space.

In another possible embodiment, the access request meeting the first condition includes the associated data needed to process the access request cannot be found in the first cache memory according to the target virtual address.

The first control unit can also be configured to obtain the associated data needed to process the access request from the cache space corresponding to the target object in response to the access request meeting the second condition. The cache space is allocated based on the resource allocation policy corresponding to the first partition identity and the second partition identity of the target object.

In another possible embodiment, the cache module includes a second control unit with communication connection and a second cache memory. The policy control module includes a second policy control module, and the second policy control module is in communication with the second control module.

The second control unit is configured to obtain an access request initiated by a target object in an electronic device; in response to the access request meeting a first condition, determine a first partition identity of the target object and a second partition identity corresponding to a physical address to be accessed by the access request.

The second policy control module is configured to determine a second resource allocation policy corresponding to the second cache memory based on the first partition identity and the second partition identity.

The second control unit is further configured to allocate corresponding cache space in the second cache memory for the target object in accordance with the second resource allocation policy.

The second cache memory is configured to cache data to be processed by the access request in the cache space.

In another embodiment, when determining the first partition identity of the target object and the second partition identity corresponding to the physical address to be accessed by the access request, the second control unit is configured to obtain the first partition identity and the second partition identity of the target object carried in the access request. The first partition identity and the second partition identity are determined by the memory management unit, and the second partition identity is determined by the memory management unit based on the physical address to which the target virtual address in the access request is mapped. The memory management unit includes a first cache memory.

In another embodiment, when caching the data to be processed by the access request in the cache space, the second cache memory is configured to, if the access request is a read request, obtain a first piece of data to be read by the read request from the internal memory of an electronic device and cache the first piece of data in the cache space; and/or, if the access request is a write request, cache the second piece of data to be processed by the write request in the cache space.

The present disclosure also provides a computer program product including computer-readable instructions. When the computer-readable instructions are executed on an electronic device, the electronic device is enabled to implement any use control method for cache resource provided in the embodiments of the present disclosure.

The present disclosure also provides a computer-readable storage medium. The computer-readable storage medium carries one or more computer programs. When one or more computer programs are executed by an electronic device, the electronic device is enabled to implement any use control method for cache resource provided in the embodiments of the present disclosure.

The device embodiments described above are merely illustrative. The units described as separate components may or may not be physically separate, and the components shown as units may or may not be physical units, i.e., they may be located in one single location or distributed across multiple network units. The objectives of the present embodiments can be achieved by selecting some or all the modules as needed. Furthermore, in the present drawings of the device embodiments, the connection relationships between modules indicate a communication connection between them, which may be one or more communication buses or signal lines.

From the above the embodiments, those skilled in the art can understand that the present disclosure can be realized by means of software and necessary general-purpose hardware, or alternatively, specific hardware, including application-specific integrated circuits, specific CPUs, specific memories, and specific components. Generally speaking, any function performed by a computer program can be easily realized by using corresponding hardware. Furthermore, the specific hardware structures used to implement the same function can vary, such as analog circuits, digital circuits, or dedicated circuits. However, for the present disclosure, software is often the preferred method. Based on this, the solution of the present disclosure, or the part that contributes to the present solution, can be realized in the form of a software product. The computer software product is stored in a readable storage medium, such as a computer floppy disk, USB flash drive, mobile hard disk, ROM, RAM, magnetic disk or optical disk, etc., and includes several instructions for enabling a computer device (which can be a personal computer, training device, or network device, etc.) to execute the methods of various embodiments of the present disclosure.

The above embodiments can be realized as a whole or in part by software, hardware, firmware or any combination thereof. The embodiments can be implemented as a whole or in part in the form of a computer programming product when using software.

The computer program includes one or more computer instructions. When the computer program instructions are loaded and executed on a computer, the process or function described in the embodiment of the present disclosure is generated in whole or in part. The computer can be a general-purpose computer, a special-purpose computer, a computer network, or other programmable devices. The computer instructions can be stored in a computer-readable storage medium or transmitted from one computer-readable storage medium to another computer-readable storage medium. For example, the computer instructions can be transmitted from a website, a computer, a training device or a data center by wired (e.g., coaxial cable, optical fiber, digital subscriber line (DSL)) or wireless (e.g., infrared, wireless, microwave, etc.) mode to another website, a computer, a training device or a data center. The computer-readable storage medium can be any available medium that a computer can store or a data storage device such as a training device, a data center, etc. that includes one or more available media integrations. The available medium can be a magnetic medium, (e.g., a floppy disk, a hard disk, a tape), an optical medium (e.g., a DVD), or a semiconductor medium (e.g., a solid-state drive (SSD)).

What is claimed is:

1. A control method comprising:
obtaining an access request initiated by a target object in an electronic device;
determining, in response to the access request meeting a condition, a first partition identity of the target object and a second partition identity corresponding to a physical address to be accessed by the access request, the second partition identity being associated with a memory space address including the physical address;
determining a target resource allocation policy based on the first partition identity and the second partition identity;
allocating corresponding cache space to the target object according to the resource allocation policy; and
caching associated data needed to process the access request in the cache space.

2. The control method according to claim 1, wherein determining the target resource allocation policy includes:
integrating the first partition identity and the second partition identity into a third partition identity; and
determining a resource allocation policy corresponding to the third partition identity as the target resource allocation policy.

3. The control method according to claim 1, wherein:
the access request includes a target virtual address of a storage space; and
determining the first partition identity and the second partition identity includes:
determining the first partition identity based on partition identities corresponding to different objects; and
obtaining, based on the target virtual address, an address mapping relationship set to obtain the second partition identity recorded in the address mapping relationship set, wherein:
the address mapping relationship set includes at least a mapping relationship between the target virtual address and the physical address; and
the second partition identity identifies a segment of memory space pointed to by the physical address.

4. The control method according to claim 3, wherein:
determining the target resource allocation policy includes determining, based on the first partition identity and the second partition identity, a resource allocation policy corresponding to a cache memory as the target resource allocation policy;
allocating the cache space includes allocating, according to the resource allocation policy corresponding to the cache memory, the cache space to the target object in the cache memory; and
caching the associated data includes caching the address mapping relationship set in the cache space.

5. The control method according to claim 1,
wherein:
the access request includes a target virtual address of a storage space; and
the condition is a first condition that the associated data is not found in the cache memory based on the target virtual address;
the control method further comprising:
obtaining, in response to the access request meeting a second condition, the associated data from the cache space allocated according to the resource allocation policy and the second partition identity.

6. The control method according to claim 1, wherein:
determining the target resource allocation policy includes determining, based on the first partition identity and the second partition identity, a resource allocation policy corresponding to a cache memory as the target resource allocation policy;
allocating the cache space includes allocating the cache space to the target object in the cache memory according to the resource allocation policy corresponding to the cache memory; and
caching the associated data includes caching data to be processed by the access request in the cache space.

7. The control method according to claim 6, wherein determining the first partition identity and the second partition identity includes:
obtaining the first partition identity and the second partition identity carried in the access request, wherein:
the first partition identity and the second partition identity are determined by a memory management unit that includes another cache memory; and
the second partition identity is determined by the memory management unit based on the physical address to which a target virtual address in the access request is mapped.

8. The control method according to claim 6, wherein:
the access request is a read request; and
caching the data to be processed by the access request in the cache space includes obtaining data to be read from an internal memory of the electronic device and caching the data in the cache space.

9. The control method according to claim 6, wherein:
the access request is a write request; and
caching the data to be processed by the access request in the cache space includes caching data to be processed by the write request in the cache space.

10. An electronic device comprising:
a processor; and
a memory storing instructions that, when executed by the processor, cause the electronic device to:
obtain an access request initiated by a target object in the electronic device;
determine, in response to the access request meeting a condition, a first partition identity of the target object and a second partition identity corresponding to a physical address to be accessed by the access request, the second partition identity being associated with a memory space address including the physical address;
determine a target resource allocation policy based on the first partition identity and the second partition identity;
allocate corresponding cache space to the target object according to the resource allocation policy; and
cache associated data needed to process the access request in the cache space.

11. The electronic device according to claim 10, wherein the instructions, when executed by the processor, further cause the electronic device to, when determining the target resource allocation policy:
integrate the first partition identity and the second partition identity into a third partition identity; and
determine a resource allocation policy corresponding to the third partition identity as the target resource allocation policy.

12. The electronic device according to claim 10, wherein:
the access request includes a target virtual address of a storage space; and
the instructions, when executed by the processor, further cause the electronic device to, when determining the first partition identity and the second partition identity:
determine the first partition identity based on partition identities corresponding to different objects; and
obtain, based on the target virtual address, an address mapping relationship set to obtain the second partition identity recorded in the address mapping relationship set, wherein:
the address mapping relationship set includes at least a mapping relationship between the target virtual address and the physical address; and
the second partition identity identifies a segment of memory space pointed to by the physical address.

13. The electronic device according to claim 12, wherein the instructions, when executed by the processor, further cause the electronic device to:
when determining the target resource allocation policy, determine, based on the first partition identity and the second partition identity, a resource allocation policy corresponding to a cache memory as the target resource allocation policy;
when allocating the cache space, allocate, according to the resource allocation policy corresponding to the cache memory, the cache space to the target object in the cache memory; and
when caching the associated data, cache the address mapping relationship set in the cache space.

14. The electronic device according to claim 10, wherein:
the access request includes a target virtual address of a storage space;
the condition is a first condition that the associated data is not found in the cache memory based on the target virtual address;
the instructions, when executed by the processor, further cause the electronic device to:
obtain, in response to the access request meeting a second condition, the associated data from the cache space allocated according to the resource allocation policy and the second partition identity.

15. The electronic device according to claim 10, wherein the instructions, when executed by the processor, further cause the electronic device to:
when determining the target resource allocation policy, determine, based on the first partition identity and the second partition identity, a resource allocation policy corresponding to a cache memory as the target resource allocation policy;
when allocating the cache space, allocate the cache space to the target object in the cache memory according to the resource allocation policy corresponding to the cache memory; and
when caching the associated data, cache data to be processed by the access request in the cache space.

16. The electronic device according to claim 15, wherein the instructions, when executed by the processor, further cause the electronic device to, when determining the first partition identity and the second partition identity:
obtain the first partition identity and the second partition identity carried in the access request, wherein:
the first partition identity and the second partition identity are determined by a memory management unit that includes another cache memory; and
the second partition identity is determined by the memory management unit based on the physical address to which a target virtual address in the access request is mapped.

17. The electronic device according to claim 15, wherein:
the access request is a read request; and
the instructions, when executed by the processor, further cause the electronic device to, when caching the data to be processed by the access request in the cache space, obtain data to be read from an internal memory of the electronic device and cache the data in the cache space.

18. The electronic device according to claim 15, wherein:
the access request is a write request; and
the instructions, when executed by the processor, further cause the electronic device to, when caching the data to be processed by the access request in the cache space, cache data to be processed by the write request in the cache space.

19. A non-transitory computer-readable storage medium storing instructions that, when executed by a processor, cause an electronic device including the processor to:
obtain an access request initiated by a target object in the electronic device;
determine, in response to the access request meeting a condition, a first partition identity of the target object and a second partition identity corresponding to a physical address to be accessed by the access request, the second partition identity being associated with a memory space address including the physical address;
determine a target resource allocation policy based on the first partition identity and the second partition identity;
allocate corresponding cache space to the target object according to the resource allocation policy; and
cache associated data needed to process the access request in the cache space.

20. The storage medium according to claim 19, wherein the instructions, when executed by the processor, further cause the electronic device to, when determining the target resource allocation policy:
integrate the first partition identity and the second partition identity into a third partition identity; and
determine a resource allocation policy corresponding to the third partition identity as the target resource allocation policy.
